(19) United States
(12) Patent Application Publication
(10) Pub. No.: US 2026/0092878 A1
(43) Pub. Date: Apr. 2, 2026

(54) MULTI-FIELD LAYER INSPECTION METHOD FOR SURFACE OF CYLINDRICAL OBJECT

(71) Applicant: ENSCAPE CO., LTD., Yongin-si (KR)

(72) Inventors: Hyeok Gi Gwon, Yongin-si (KR); Ji Man Ryu, Suwon-si (KR); Seong Gi Kim, Cheonan-si (KR); In Ho Ka, Seongnam-si (KR); Sang Jin Choi, Seongnam-si (KR); Sang Baek Kim, Seongnam-si (KR)

(21) Appl. No.: 18/940,003

(22) Filed: Nov. 7, 2024

(30) Foreign Application Priority Data
Sep. 30, 2024 (KR) 10-2024-0133277
Oct. 17, 2024 (KR) 10-2024-0142257

(51) Int. Cl. G01N 21/952; G01N 21/88; H01M 10/42

(52) U.S. Cl. CPC G01N 21/952; G01N 21/8806; H01M 10/4285; G01N 2021/8825; G01N 2201/06146

(57) ABSTRACT

Disclosed is a multi-field layer inspection method for the surface of a cylindrical object, in which several areas for bright, dark, and edge fields are extracted from multiple images, and these extracted areas are combined to form a complete lateral area in each field, enabling accurate detection of recessed defects below the reference plane, protruding defects above it, as well as planar defects.

### CROSS REFERENCE TO RELATED APPLICATIONS

This application claims priority to and the benefit of Korean Patent Application Nos. 10-2024-0133277 filed on Sep. 30, 2024 and 10-2024-0142257 filed on Oct. 17, 2024, the entire disclosure of which is incorporated by reference herein.

### BACKGROUND OF THE INVENTION

### Field of the Invention

The disclosure relates to a multi-field layer inspection method for the surface of a cylindrical object, and more particularly to an inspection method improved in accuracy in identifying defects on a cylindrical surface.

This application is one of the results of the Materials and Components Technology Development Program (R&D) (Development of an integrated optical system and AI vision inspection system for testing/measuring next-generation 4680˜46200 cylindrical batteries, project identification number: RS-2024-00418621) under the supervision of the Ministry of Trade, Industry, and Energy of the Republic of Korea.

### DESCRIPTION OF THE RELATED ART

A method of optically inspecting the surface of a cylindrical object refers to a method of generally using an optical system such as a camera, lighting, and a laser to visually analyze defects or irregularities on the surface.

In connection with this technology for inspecting the cylindrical outer appearance of metal, Korean Patent No. 1030450 has been disclosed.

In the case of a cylindrical object, such related art has difficulty in acquiring an accurate inspection image due to the curvature of the surface. Further, in particular, in the case of an object from which visible light is reflected, such as metal, there is a problem that it is further difficult to identify defects.

### SUMMARY OF THE INVENTION

An aspect of the disclosure is to provide a multi-field layer inspection method for the surface of a cylindrical object, which solves a conventional problem of low accuracy in outer appearance inspection for the surface of a cylindrical object.

According to the disclosure, there is provided a multi-field layer inspection method for the surface of a cylindrical object, the method including: irradiating light from the front and back of the cylindrical object; acquiring an image captured by a camera while irradiating the light; extracting a first area having a predetermined width, which is brightest within a lateral side of the cylindrical object, from the image; extracting a second area showing an edge within the lateral side from the image, extracting a third area between the first area and the second area from the image, generating a bright field image by merging the first areas at a plurality of angles, generating an edge field image by merging the second areas at a plurality of angles, generating a dark field image by merging the first areas at a plurality of angles, and identifying a defect in the cylindrical object based on the bright field image, the edge field image, and the dark field image, wherein the light irradiation and the image acquisition are performed whenever the cylindrical object is adjusted in angle.

Meanwhile, the first area may be an area including a portion where an optical axis of the camera is perpendicular to the lateral side.

Further, the first area may be defined to include an area that is closest to being flat when viewed through the camera.

Meanwhile, the second area may be darker than the first area.

Further, the light irradiation may be performed using a backlight part configured for surface emission in the back.

In addition, the light irradiation may be performed using a coaxial lighting part coaxial with the camera in the front.

Further, the defect identification may be performed using an image of which contrast has been adjusted based on the dark field image.

Meanwhile, the cylindrical object may include a secondary battery or a can for the secondary battery.

### BRIEF DESCRIPTION OF THE DRAWINGS

FIG. 1 is a flowchart of a multi-field layer inspection method for the surface of a cylindrical object according to an embodiment of the disclosure.

FIG. 2 is a conceptual view of an inspection apparatus in which a multi-field layer inspection method for the surface of a cylindrical object is implemented according to an embodiment of the disclosure.

FIG. 3 is a conceptual view of another inspection apparatus in which a multi-field layer inspection method for the surface of a cylindrical object is implemented according to an embodiment of the disclosure.

FIG. 4 is a view showing an initial image taken according to an embodiment of the disclosure.

FIG. 5 is a graph showing gray values in the widthwise direction of a cylindrical object according to the disclosure.

FIG. 6 is a view showing areas defined in a taken image according to the disclosure.

FIG. 7 is a view showing a bright field image based on a first area according to the disclosure.

FIG. 8 is a view showing an edge field image based on a second area according to the disclosure.

FIG. 9 is a view showing a dark field image based on a third area according to the disclosure.

FIG. 10 is a flowchart of a multi-field layer inspection method for the surface of a cylindrical object according to another embodiment of the disclosure.

### DETAILED DESCRIPTION OF THE INVENTION

Below, a multi-field layer inspection method for the surface of a cylindrical object according to an embodiment of the disclosure will be described in detail with reference to the accompanying drawings. In the following description, the names of components used may be referred to as other names in this art. However, these components may be considered as equivalent components in alternative embodiments if they are functionally similar or identical to each other. Further, the reference numerals of the components are merely given for the convenience of description. However, the components indicated by the reference numerals in the accompanying drawings are not limited by those shown therein.

Likewise, if components are functionally similar or identical to each other even though they are partially modified in the drawings according to alternative embodiments, the components may be considered as the equivalent components. Further, when components are recognized as components that should be included at the level of those skilled in the art, they are not described. In addition, if it is obvious to those skilled in the art that a component should be included, descriptions thereof will be omitted.

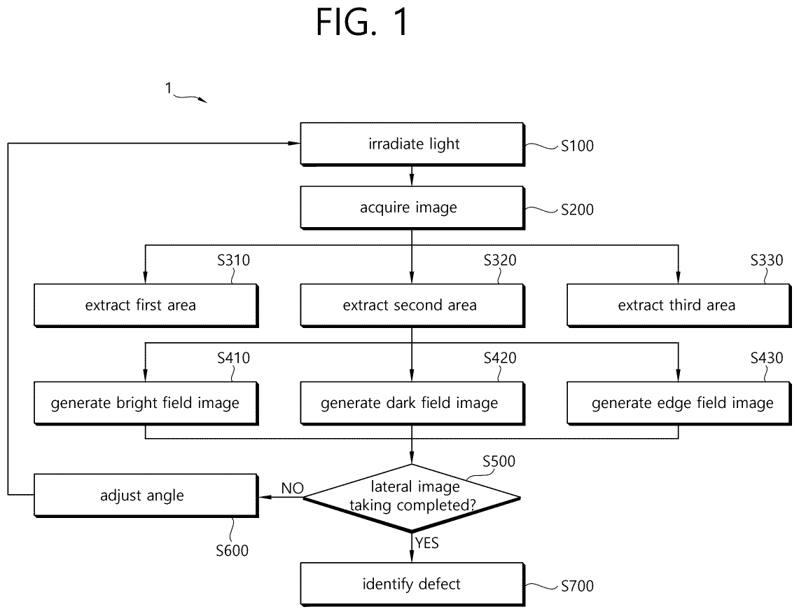

FIG. 1 is a flowchart of a multi-field layer inspection method for the surface of a cylindrical object according to an embodiment of the disclosure.

Referring to FIG. 1, a multi-field layer inspection method 1 for the surface of a cylindrical object according to an embodiment of the disclosure may include steps of irradiating light (S100), acquiring an image (S200), extracting a first area (S310), extracting a second area (S320), extracting a third area (S330), generating a bright field image (S410), generating a dark field image (S420), generating an edge field image (S430), identifying whether lateral image taking is completed (S500), adjusting an angle (S600), and identifying a defect (S700).

In the step S100 of irradiating the light, coaxial lighting and backlight are used to irradiate the cylindrical object with light. The coaxial lighting projects light directly onto the object so that a camera can accurately capture light reflected from the surface, and the backlight has an effect on highlighting the edges by irradiating light from behind the object. The coaxial lighting is advantageous for the inspection as a difference in texture or reflectance on the surface of the cylindrical object is emphasized, and the backlight helps to detect the overall shape of the object as the outline (edge) of the object is better revealed.

In the step S200 of acquiring the image, the camera is used to take the image of the cylindrical object. This step may be performed while the light is irradiated in the foregoing step S100.

The step S310 of extracting the first area corresponds to a step of extracting the first area by analyzing the brightest area in an initial image acquired by the camera. The first area refers to a portion from which the irradiated light is reflected, i.e., an area having the highest reflectivity on the surface of the object. Because the lateral surface is curved, the lateral surface may be the brightest in a portion including an area intersected with an optical axis of the camera. The brightest area on the image is an area that is closest to being flat when viewed through the camera.

The step S320 of extracting the second area corresponds to a step of extracting the second area by detecting an edge portion in the initial image. The edge is a boundary between a bright area and a dark area, and refers to a portion where clarity is clear. The second area is defined as an area including the boundary of the cylindrical object.

The step S330 of extracting the third area refers to a step of extracting the third area based on a portion, from which lighting is weakly reflected, on the surface of the cylindrical object. The third area is a portion where the lighting is not evenly diffused, thereby exhibiting the texture or light absorption characteristics.

The step S410 of generating the bright field image refers to a step of generating the bright field image by collecting only the first areas (bright areas) from the initial image taken for each angle. This image contains the most reflective surfaces of the object.

In the step S420 of generating the dark field image, the dark field image is generated by collecting only the third areas (middle dark areas) from the image taken for each angle. In dark field image, non-reflective portions on the surfaces are highlighted and extracted.

The step 430 of generating the edge field image corresponds to a step of generating the edge field image by collecting only the second areas (edge areas) from the image taken for each angle.

The step S500 of identifying whether the lateral image taking is completed corresponds to a step of taking images of the lateral surfaces of the cylindrical object at various angles and identifying whether the cylindrical object has rotated a full 360 degrees.

The step S600 of adjusting the angle corresponds to a step of rotating the cylindrical object at a preset angle when it is identified that the cylindrical object has not rotated the full 360 degrees. The step S100 of irradiating the light to the steps 410, 420 and 430 of generating the images may be performed repeatedly.

The step S700 of identifying the defect corresponds to a step of detecting defects based on the bright field image, the edge field image and the dark field image, which are generated when it is identified in the step S500 of identifying whether the lateral image taking is completed that the cylindrical object has rotated the full 360 degrees. Here, the defects may be detected by comprehensively evaluating the uniformity on the surface, the clarity of the edges, the reflective characteristics in the bright area, etc. based on the acquired images.

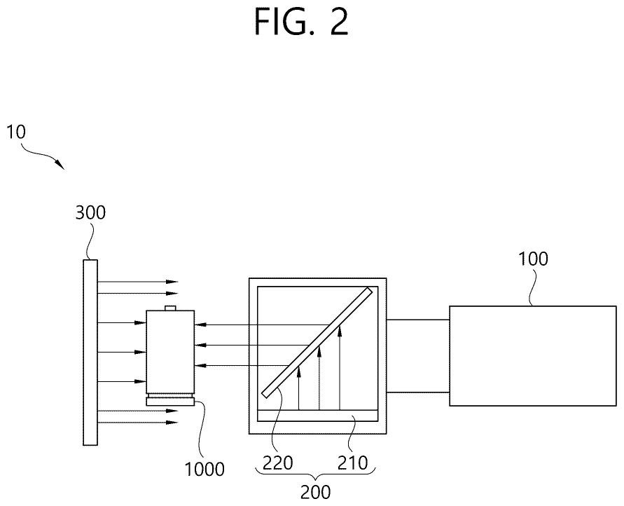

FIG. 2 is a conceptual view of an inspection apparatus in which a multi-field layer inspection method for the surface of a cylindrical object is implemented according to an embodiment of the disclosure.

Referring to FIG. 2, the multi-field layer inspection method for the surface e of the cylindrical object implemented in an outer-appearance inspection apparatus.

The outer-appearance inspection apparatus may be configured to inspect a cylindrical object, for example, a cylindrical secondary battery 1000.

The outer-appearance inspection apparatus may include a coaxial lighting part 200, a seating portion, a backlight part 300, a camera 100, and an image processor.

The coaxial lighting portion 200 may be configured to irradiate light to the lateral side of the secondary battery 1000 coaxially with the camera 100. The coaxial lighting portion 200 may include a semi-reflective mirror 220 and a coaxial lighting unit 210. The semi-reflective mirror 220 may be disposed at an angle of 45 degrees on the optical path of the camera 100. Meanwhile, the semi-reflective mirror may be provided at an angle in the longitudinal direction of the cylindrical object 1000.

The seating portion (not shown) may be adjustable in angle in the state that the secondary battery is seated thereon. The seating portion may be disposed not to be captured by the camera 100. According to an embodiment, the seating portion may be disposed to be completely hidden behind the secondary battery while the camera 100 takes an image.

The backlight portion 300 has a larger area than the secondary battery and is configured for surface emission.

The camera 100 may be configured to acquire the images while the backlight portion 300 and the coaxial lighting portion 200 are operating.

The image processor may be configured to generate the bright field image, the dark field image and the edge field image from the acquired initial image, and identify external defects.

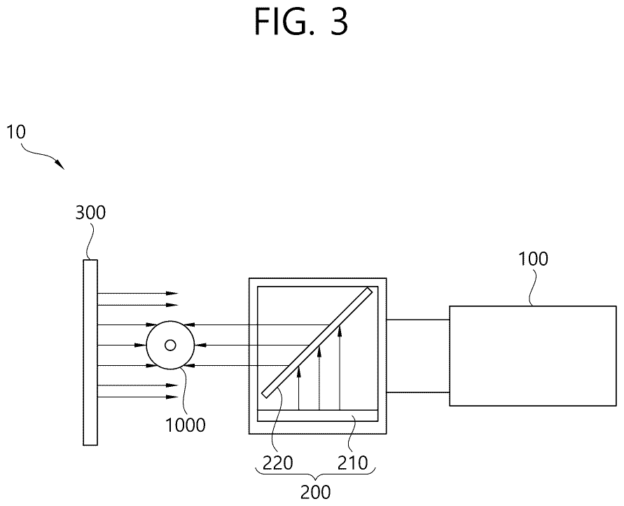

FIG. 3 is a conceptual view of another inspection apparatus in which a multi-field layer inspection method for the surface of a cylindrical object 1000 is implemented according to an embodiment of the disclosure.

This embodiment may also include the same components as those of the foregoing embodiment, and repetitive descriptions thereof will be avoided. Below, only different components will be described.

Referring to FIG. 3, the inspection apparatus where the inspection method according to this embodiment of the disclosure may include a semi-reflective mirror 220 of the coaxial lighting portion 200, which is provided at an angle in the widthwise direction of the cylindrical object 1000. Therefore, when there is a plurality of coaxial lighting units 210, light may be irradiated in sequence in the widthwise direction of the cylindrical object 1000. This configuration of the coaxial lighting improves accuracy in detecting defects.

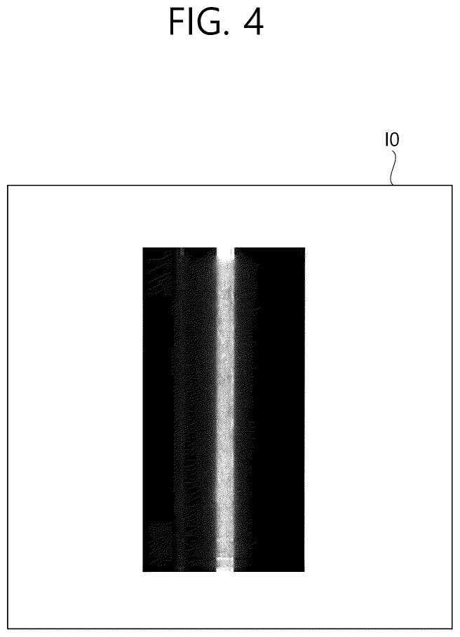

FIG. 4 is a view showing an initial image taken according to an embodiment of the disclosure.

Referring to FIG. 4, an initial image IO acquired by the camera according to an embodiment of the disclosure shows a secondary battery, in which the image is very bright in a central portion due to the curvature of the lateral side of the secondary battery, and becomes darker toward both edges in the widthwise direction.

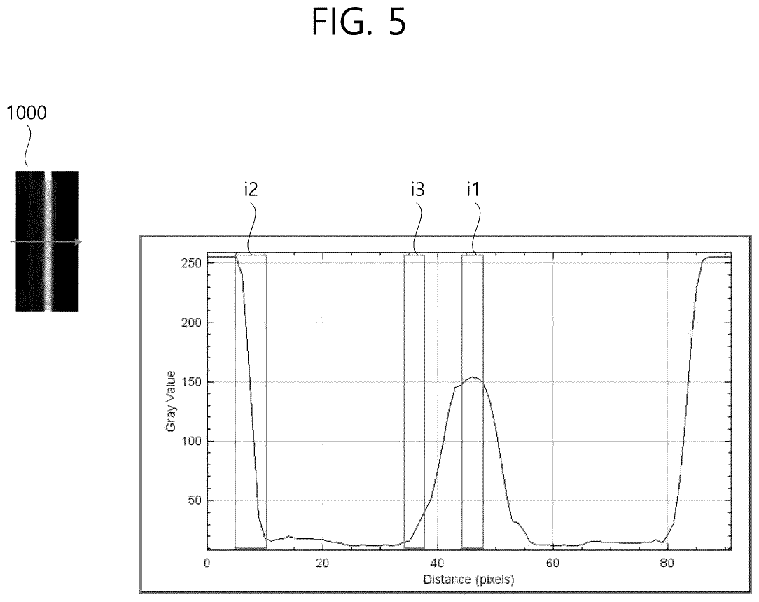

FIG. 5 is a graph showing gray values in the widthwise direction of a cylindrical object 1000 according to the disclosure.

Referring to FIG. 5, along the widthwise direction, a gray value of ‘255’ indicates pure white and a gray value of ‘0’ indicates pure black. According to positions in the widthwise direction, the central portion is brightest, and an area having a certain gray value or more within the brightest area may be defined as the first area. For example, the first area i1 may have a gray value greater than or equal to ‘100.’

The second area i2 corresponds to an edge portion that is furthest from the center, and may be set as an area where the gray value changes rapidly.

The third area i3 corresponds to a dark portion having a gray value less than ‘50,’ and may be defined as a certain area positioned at a predetermined distance away from the central portion.

However, the first area i1, the second area i2, and the third area i3 are merely examples, and may be variously set according to the reference gray values for dividing the areas and the distances from the central portion.

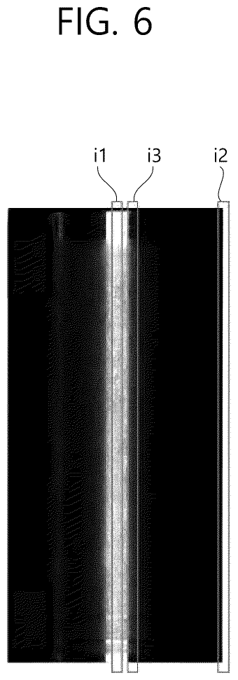

FIG. 6 is a view showing areas defined in a taken image according to the disclosure.

Referring to FIG. 6, according to the disclosure, the step S310 of extracting the first area, the step S320 of extracting the second area, and the step S330 of extracting the third area may be performed based on the foregoing gray values and the distances from the central portion after performing the step S200 of acquiring the image. The first area i1, the second area i2 and the third area i3 may be extracted regardless of order.

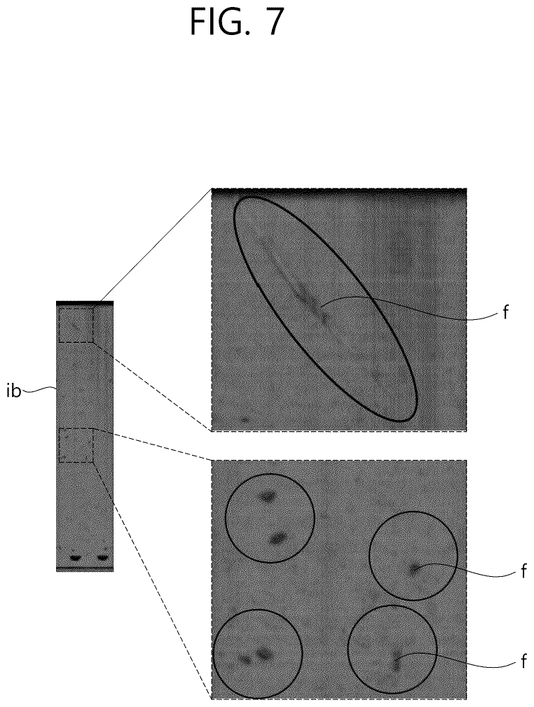

FIG. 7 is a view showing a bright field image based on a first area according to the disclosure.

Referring to FIG. 7, the step S410 of generating the bright field image includes generating a single complete lateral bright field image ib by merging portions of an image, which show the first area extracted for each angle. Based on the bright field image, the step S700 of identifying a defect may be performed. Information about various defects is collected in the bright field image ib acquired based on the bright portions.

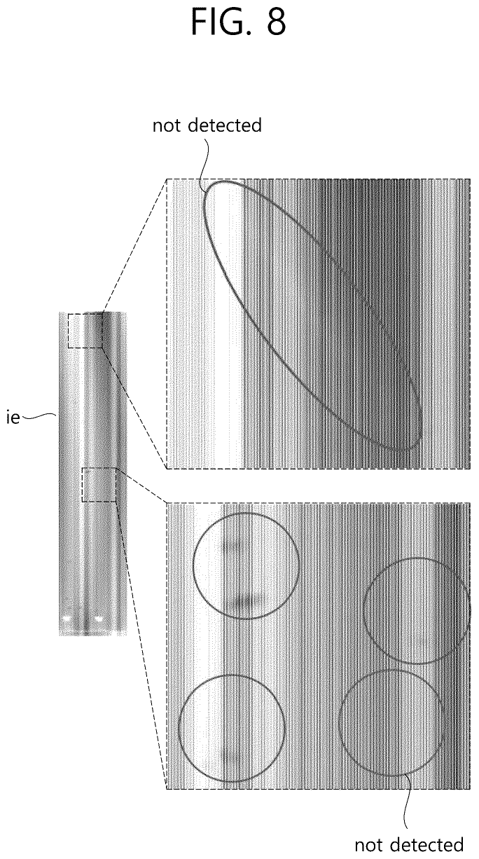

FIG. 8 is a view showing an edge field image based on a second area according to the disclosure.

Referring to FIG. 8, a single complete lateral edge field image ie is generated by merging portions of an image, which show the second area i2 for each angle. In the step S700 of identifying a defect, the edge field image may be used to detect defects f higher than the surface. Such defects may for example include foreign materials attached to the surface. Only defects with significant height are detected, while other types of defects are difficult to identify in the edge field image ie.

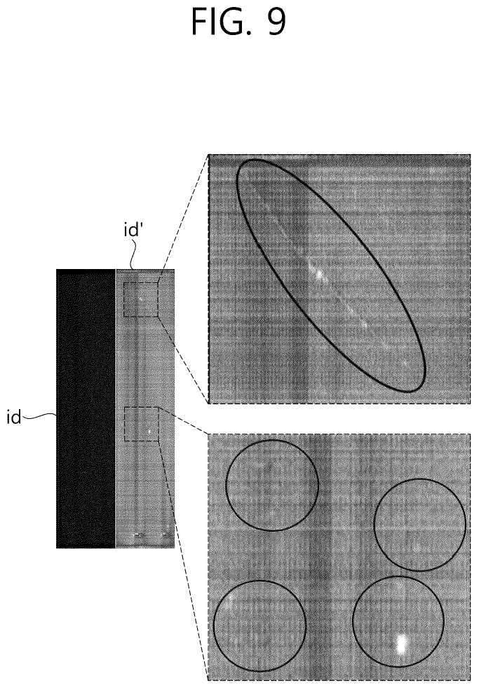

FIG. 9 is a view showing a dark field image based on a third area according to the disclosure.

Referring to FIG. 9, a single complete lateral dark field image id is generated by merging portions of an image, which show the third area i3 for each angle. Because the dark field image id in this case has a low gray value, the image processor may adjust the contrast of the generated dark field image to an appropriate level. In the step S700 of identifying a defect, the dark field image may be used to identify defects lower than the surface. Such defects may include physical defects such as dents or scratches.

In other words, in the step S700 of identifying a defect, specifically, most defects and defects at the same height as the surface, such as surface contamination and rust may be detected through the bright field image. Further, the characteristics of the dark field image where only defects are brightly expressed on a black background may be used to detect defects causing inward changes in shape due to damage on the surface of a product, such as scratches and dents. In addition, the characteristics of the edge field image where only defects are darkly expressed on a background may be used to detect defects causing outward changes in product shape, such as externally attached foreign materials or floating foreign materials.

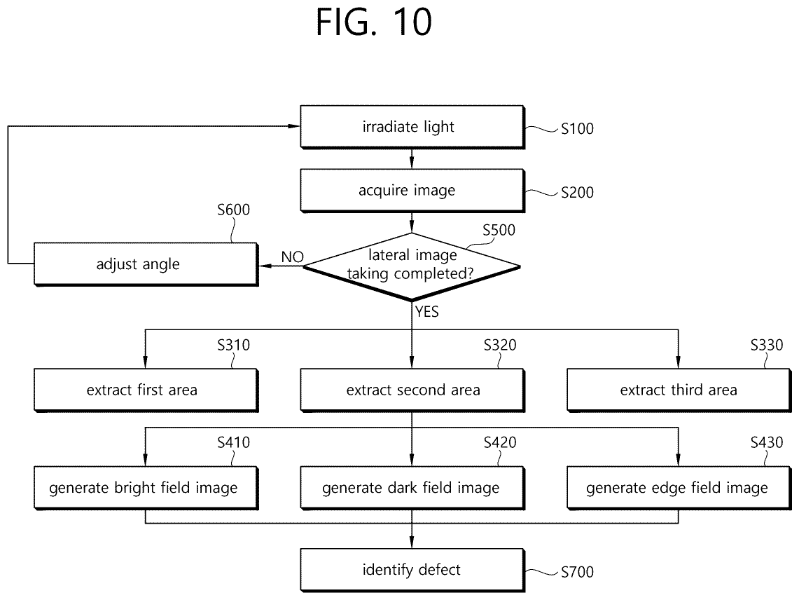

FIG. 10 is a flowchart of a multi-field layer inspection method for the surface of a cylindrical object according to another embodiment of the disclosure.

Referring to FIG. 10, a multi-field layer inspection method for the surface of a cylindrical object according to this embodiment of the disclosure may include extracting areas after acquiring a plurality of images captured for respective angles (S310, S320 and S330) and then generating field images (S410, S420 and S430).

Therefore, when the cylindrical object has not rotated a full 360 degrees yet in the step S500 of identifying whether the lateral image taking is completed, the step S600 of adjusting an angle and the step of acquiring an image may be performed repeatedly.

Although the areas are extracted and the field images are generated after the initial images are first acquired as in this embodiment, the same effects as that of the disclosure are made.

As described above, the multi-field layer inspection method for the surface of the cylindrical object according to an embodiment of the disclosure extracts several areas for respective fields from several initial images, and merges the extracted areas into a complete lateral image, thereby detecting a defect. Accordingly, the inspection is improved in speed and accuracy.

According to the disclosure, a multi-field layer inspection method for the surface of a cylindrical object has effects on improving the speed of inspecting the outer appearance of the cylindrical object and the accuracy in the inspection.

What is claimed is:

1. A multi-field layer inspection method for the surface of a cylindrical object, the method comprising:
irradiating light from the front and back of the cylindrical object;
acquiring an image captured by a camera while irradiating the light;
extracting a first area having a predetermined width, which is brightest within a lateral side of the cylindrical object, from the image;
extracting a second area showing an edge within the lateral side from the image;
extracting a third area between the first area and the second area from the image;
generating a bright field image by merging the first areas at a plurality of angles;
generating an edge field image by merging the second areas at a plurality of angles;
generating a dark field image by merging the first areas at a plurality of angles; and
identifying a defect in the cylindrical object based on the bright field image, the edge field image, and the dark field image,
wherein the light irradiation and the image acquisition are performed whenever the cylindrical object is adjusted in angle.

2. The method of claim 1, wherein the first area is an area comprising a portion where an optical axis of the camera is perpendicular to the lateral side.

3. The method of claim 1, wherein the first area is defined to comprise an area that is closest to being flat when viewed through the camera.

4. The method of claim 2, wherein the second area is darker than the first area.

5. The method of claim 4, wherein the light irradiation is performed using a backlight part configured for surface emission in the back.

6. The method of claim 5, wherein the light irradiation is performed using a coaxial lighting part coaxial with the camera in the front.

7. The method of claim 1, wherein the defect identification is performed using an image of which contrast has been adjusted based on the dark field image.

8. The method of claim 1, wherein the cylindrical object comprises a secondary battery or a can for the secondary battery.
